(19) United States
(12) Patent Application Publication
(10) Pub. No.: US 2011/0219097 A1
(43) Pub. Date: Sep. 8, 2011

(54) Techniques For Client Device Dependent Filtering Of Metadata

(75) Inventor: Brett Graham Crockett, Brisbane, CA (US)

(73) Assignee: DOLBY LABORATORIES LICENSING CORPORATION, San Francisco, CA (US)

(21) Appl. No.: 13/037,577

(22) Filed: Mar. 1, 2011

Related U.S. Application Data
(60) Provisional application No. 61/310,403, filed on Mar. 4, 2010.

(51) Int. Cl. G06F 15/16

(52) U.S. Cl. 709/219

(57) ABSTRACT

Methods and apparatuses for media data communication for improved bandwidth utilization are provided. A client device communicates profile information to a server. The server maintains media content data and first metadata category information associated with the media content data. Based upon the profile information, a determination is made as to whether the client device is to utilize the first metadata category information. If to be utilized, media content data as well as the first metadata category information is provided to the client device. If a non-utilization determination is made, media content data is provided without the first metadata category information. In exemplary embodiments, first metadata category information can relate to any of the following: closed captioning, speaker virtualization, three dimensional rendering, global positioning, audio and/or video codecs, volume control, and the like.

### CROSS REFERENCE TO RELATED APPLICATIONS

This application claims priority to U.S. Provisional Patent Application No. 61/310,403 filed 4 Mar. 2010, hereby incorporated by reference in its entirety.

### TECHNOLOGY

The present invention relates generally to data communication, and in particular, to improved optimization of bandwidth usage for streaming media with metadata.

### BACKGROUND

Metadata, or “data about data,” can be pre-computed during content aggregation and encoding and streamed along with content. This metadata (whether audio and/or video metadata) conveys detailed information about the content that can be used to perform high quality audio-visual (A/V) post-processing without using the restricted resources of a client device, such as a cellular telephone.

While metadata can be very useful and provide improved A/V quality with reduced processing requirements, the bandwidth of the streamed metadata can grow to a significant percentage of the bit rate compared to the data rate of the compressed audio or video stream, particularly for audio. This bandwidth problem amplifies as metadata elements increase to provide information for specific algorithms or as metadata becomes dynamic (e.g., conveying metadata that varies from frame to frame to reflect the changing nature of the underlying content).

From the above, it is seen that techniques for improved bandwidth utilization for metadata transport is desirable.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### SUMMARY OF THE DESCRIPTION

Methods and apparatuses for media data communication for improved bandwidth utilization are provided. Profile information of a client device is received by a computerized server. The computerized server maintains media content data and first metadata category information associated with the media content data. Based upon the profile information, a determination is made as to whether the client device is to utilize the first metadata category information. If it is to be utilized, media content data as well as the first metadata category information is transmitted to the client device. On the other hand, if a non-utilization determination is made, media content data is transmitted without the first metadata category information.

In one embodiment, a method for media data communication by a computerized server includes receiving profile information of a client device. The server maintains media content data, first metadata category information and second metadata category information. The first and second metadata category information each are associated with the media content data. The server determines, based on the profile information, whether the client device is to utilize either the first metadata category information or the second metadata category information. In the event expected utilization of the first metadata category information, the server transmits the media content data and the first metadata category information to the client device without transmitting the second metadata category information. Conversely, for expected utilization of the second metadata category information, the server transmits the media content data and the second metadata category information to the client device without transmitting the first metadata category information.

In another embodiment, a client device transmits profile information of the client device to a server. The profile information indicates, directly or indirectly, at least one accessible or enabled function of the client device. The client device receives media content data and associated first metadata category information. The first metadata category information includes a parameter used by the function. The client device does not receive second metadata category information associated with the media content data from the computerized server. The second metadata category information includes one or more parameters not expected to be used by the function.

In yet another embodiment, a communication system includes a receiver, database (or alternatively any non-transitory data storage memory), processor, and transmitter. Profile information of a client device is received by the receiver. The database maintains media content data and first metadata category information. The processor determines, based on the profile information, whether the client device is to utilize the first metadata category information. Lastly, the transmitter streams (e.g., makes available a sequence of data elements over time), directly or indirectly, the media content data with or without the first metadata category information to the client device dependent upon the determination.

As another embodiment, a client device can transmit, directly or indirectly, profile information to a server. The profile information indicates an accessible function of the client device. In response, the client receives first metadata category information associated with either media content data or the accessible function. The media content data can be stored on the client device prior to the transmission of the profile information. In fact, the media content data need not be stored or available to the server at all. The client device uses first metadata category information to process and/or render the media content data.

### BRIEF DESCRIPTION OF DRAWINGS

The present invention is illustrated by way of example, and not by way of limitation, in the figures of the accompanying drawings and in which like reference numerals refer to similar elements and in which:

FIG. 1 illustrates an exemplary communication system and components according to an embodiment of the present invention;

FIGS. 2A and 2B illustrate simplified block diagrams according to embodiments of the present invention;

FIG. 3 illustrates a simplified flow diagram according to an embodiment of the present invention; and

FIG. 4 illustrates a simplified flow diagram according to another embodiment of the present invention.

### DETAILED DESCRIPTION OF EXAMPLE POSSIBLE EMBODIMENTS

Device dependent metadata filtering improves bandwidth optimization. A client device (e.g., a cell phone, wireless media player, notebook PC or the like) can utilize its two-way data connection with a server to identify itself and/or its processing capabilities. As a result, the server can filter metadata to be transmitted to the client device for bandwidth usage reduction. For example, if a client device includes Dolby Volume®, then the server could strip out all metadata that is not relevant to Dolby Volume prior to streaming. As yet another example, if the client device does not include an integrated speaker, the server could strip out speaker virtualization metadata and leave in headphone metadata.

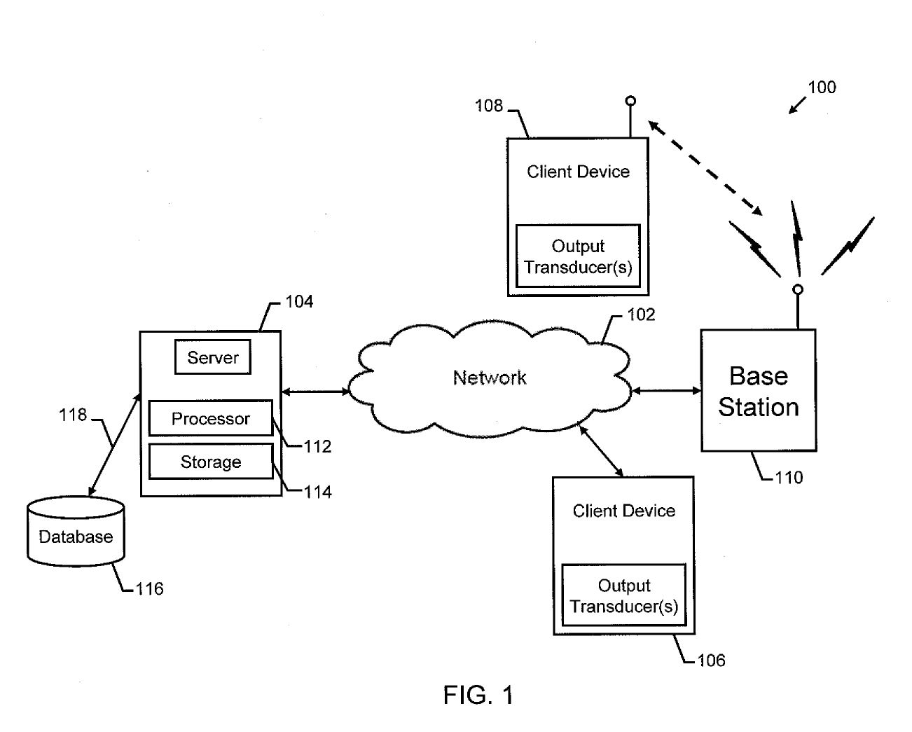

FIG. 1 illustrates an exemplary communication system 100 and components according to an embodiment of the present invention. Media data is streamed over network 102, or otherwise communicated, from server 104 to one or more client devices, such as client device 106. Client device 106 can process the media data and playback on output transducers (e.g., video display screen, audio loudspeakers, audio headphones, Bluetooth headset or the like). This media data includes media content data and, in most instances, at least one category of metadata: information conveying details about the media content or parametric information that can be used to perform post-processing by a client device, including high quality audio-visual (A/V) post-processing.

As one a particular example, client device 106 is a personal audio playback device, and the output transducers include a headset for listening to audio programming streamed via the network 102. As another particular example, the client device 106 is a personal video playback device, and the output transducers include a display screen for viewing video data streamed via the network 102. In either case, the media data is streamed for rendering at the client devices 106, and the client device 106 renders the media data for listening/and or viewing via the one or more output transducers.

In communication system 100, network 102 may be comprised of many interconnected computer systems and communication links. Network 102 can be the Internet, a local area network (LAN), wide area network (WAN), metropolitan area network (MAN), a wireless network, a wireless LAN (WLAN), wireless wide area network (WWAN), a private network, a public network, a switched network, a cellular network, a satellite network, cable television network, or a global positioning system. The interface between network 102, server 104 and client device 106 may be implemented using any recognized communication protocol for data exchange (e.g., DHCP, TCP/IP, SNTP, or others).

Network 102 is also coupled to a base station 110 in this exemplary system 100. Base station 110 is configured to wirelessly communicate with a client device 108, typically a resource constrained device (e.g., a portable electronic device that is operated by battery power or otherwise has limited computational processing power). Client device 108 can process the media data and playback on at least one output transducer. “Base station” is a term commonly used in describing cellular communication networks for a radio receiver/transmitter hub for cellular devices, and its use herein is also synonymous and interchangeable with “access point,” a term commonly used in describing infrastructure type wireless local area networks.

Server 104 can be a media server, a source of the media data. Server 104 includes a processor 112 and a computer readable storage subsystem 114—the storage subsystem 114 having memory and possible one or more other storage elements such as optical and/or magnetic media systems. The storage subsystem includes instructions that when executed by the processor 112 cause the server to serve media data via the network 102.

In an alternative embodiment, server 104 can be coupled to a remote database 116 via communication link 118. Communication link 118 can be a wired or wireless, direct or indirect, communication channel. In fact, communication link 118 can be network 102, or a portion thereof. Database 116 can store media content data for streaming, as well as authorizations of client device (e.g., authorized/paid services or media available to a registered client device).

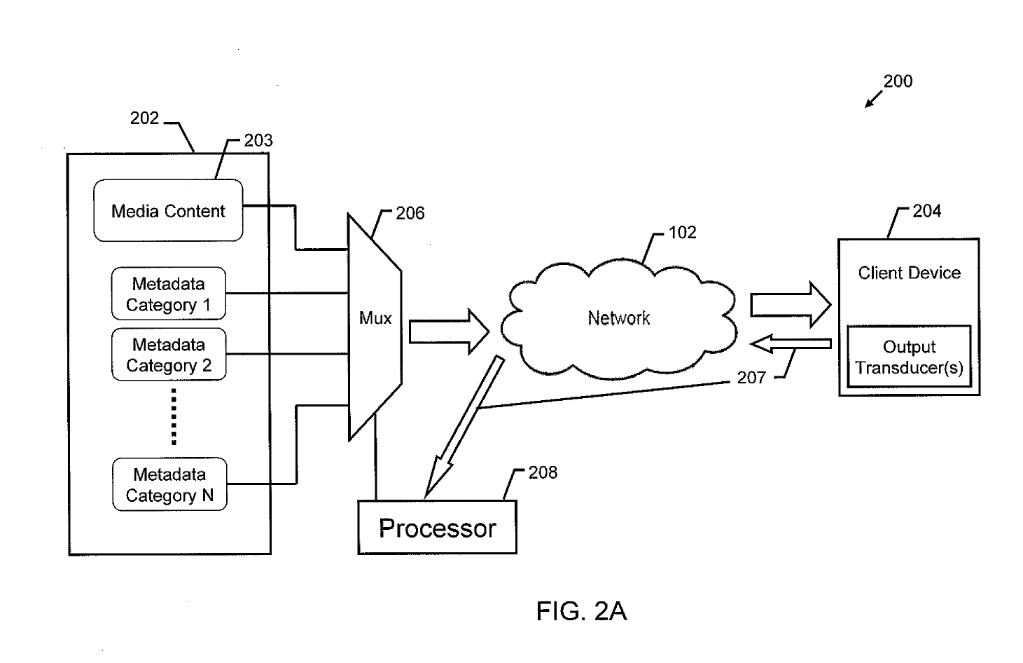

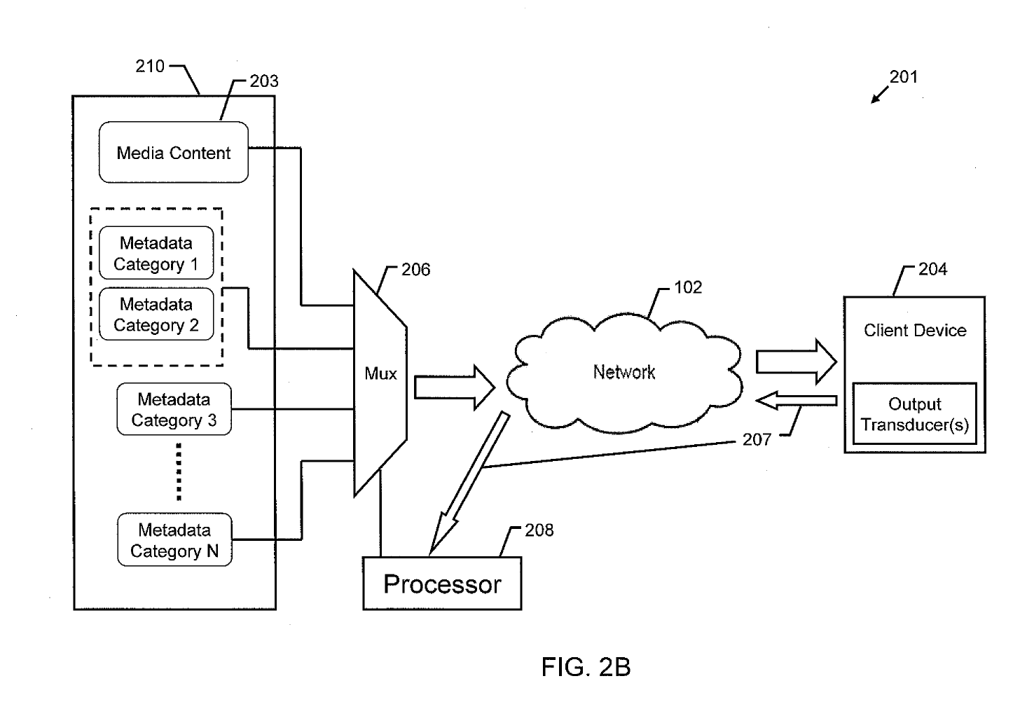

FIG. 2A illustrates a simplified block diagram 200 according to embodiment of the present invention. As shown in FIG. 2A, media data 202 includes media content data 203 and a plurality of metadata categories (e.g., metadata category 1, 2, . . . N). That is to say, metadata resident on a server or database can be logically organized into categories. Metadata relating to audio loudspeaker virtualization can be grouped together as one category, while metadata associated with audio headphone playback can be grouped as another category. Metadata categories can include, without limitation: global positioning parameters, video or audio codec parameters, Dolby Volume® parameters, Dolby Digital parameters, closed captioning parameters, three dimensional rendering parameters, or two dimensional rendering parameters. It should be understood, that based on the teachings herein, one can formulate other metadata categories useful for A/V post-processing. It should be further understood that metadata for a category need not be stored contiguously in a memory, but merely that one or more parameters be logically associated by the server or database as being desirable for a specific function.

Portions of media data 202 can be streamed over network 102 to client device 204, a client device similar or same to either client devices 106 or 108. Processor 208 can control a multiplexer 206, a device that combines several input information signals into one output signal, to output media content 203 and each of the desired metadata categories. Each of processor 208 and multiplexer 206 can be included in a server, such as exemplary server 104, or alternatively as distinct components.

Before a server streams portions of the media data 202 to client device 204, it queries client device 102 for capabilities and/or identity to select appropriate metadata categories for streaming or transmission. In response to the query, client device 204 provides profile information 207. In alternative embodiments, client device 204 can provide profile information 207 automatically and without a server query. For example, client device 204 can transmit profile information 207 upon: power-up, initialization of the communication channel, or changes in user settings.

Profile information 207 can include any information useful to a server to determine the desirable metadata categories to be communicated to the client device 204. As an example, profile information 207 can solely be a device identifier (whether unique or general, encrypted or unencrypted), such as a media access control (MAC) address, Ethernet hardware address (EHA), unique item identifier (UID), universal product code (UPC), electronic product code (EPC), short message service (SMS) bCode, cipher code, or the like. In these instances, the server may directly determine the type of device and/or its configuration. For example, the server can determine that client device 204 is an iPod Shuffle® (without video display) instead of an Apple iPod Nano® (with video display), both sold by Apple Inc. In this simple example, metadata categories related to video rendering need not be streamed to the iPod shuffle. Taking this example one step further, metadata categories related to video rendering need not be streamed to an iPod nano if the video display is dimmed/turned-off.

As an alternative, the server can access a database using the device identifier to determine a configuration of client device 204, particularly if client device 204 has pre-registered its capabilities or desired functions. If the server provides on-demand services, the device identifier can be used to confirm paid functions/services in order to provide only authorized metadata categories (and conversely, not provide unauthorized metadata categories).

Profile information 207 can take other forms beside a device identifier. Profile information 207 can, for example, specifically indicate device configuration, available output transducer(s), device operating system software, or video and/or audio decoding capabilities (e.g., H.264, VC-1, advanced audio coding (AAC), Dolby Volume®, Dolby Digital, etc.).

In some instances, it is advantageous that profile information 207 be dynamically and/or periodically updated. Additional communication bandwidth can be saved based on the contemporary needs of client device 204. Metadata categories associated with features disabled by an end user need not to be communicated. In opposite, metadata categories associated with features enabled by an end user can be communicated. Accordingly, selection can be dynamic based on user input. For example, if audio output transducers of client device 204 are muted by the end user, then metadata categories associated with sound reproduction are not streamed. Similarly, if a video display is turned off on client device 204, then metadata categories associate with video rendering are not streamed. As another example, the user can disable high fidelity processing features thereby eliminating the need to stream associated parametric information.

FIG. 2B illustrates a simplified block diagram 201 according to embodiment of the present invention. In this embodiment, media data 210 differs in certain aspects from previous example media data 202. Specifically, metadata category 1 information is mutually exclusive of (or merely negatively associated with) metadata category 2 information. By either operation of control logic (e.g., multiplexer 206 and/or processor 208), database organization, or other control means, either metadata category 1 information or metadata category 2 information can be streamed to client device 204, but not both (unless this restriction is overridden). In some instances, the use of metadata category 1 information can be incompatible with the use of metadata category 2 information. In other instances, use of one category information will make another category information unnecessary. By way of example, category 1 information may pertain to 3D video rendering, while category 2 information may pertain to 2D video rendering. In typical circumstances, client device 204 will not require both 3D and 2D information for the same media content.

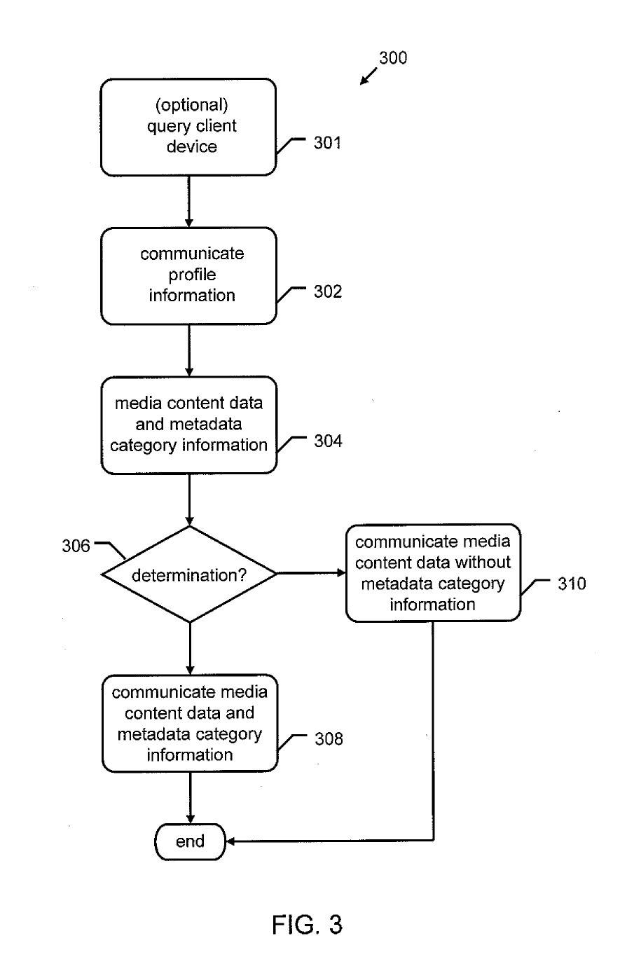

FIG. 3 illustrates a simplified flow diagram 300 according to an embodiment of the present invention. In step 301, a client device can be first queried for profile information. In response to the query or upon the occurrence of a predefined event, the client device communicates profile information to a server in step 302. The predefined event can include: user input (for example, change in device configuration), power-up, initialization of a software application, initialization/availability of a communication channel (e.g., WiFi, 3G or 4G cellular network, or high speed Internet access). Next, in step 304, the server accesses media content data and its associated metadata category information. A determination for metadata categories to be communicated, based at least in part upon the profile information, is made in step 306. Finally, desirable metadata category information is provided to the client device in step 308, or otherwise omitted if such metadata is undesirable in step 310. Other alternatives can also be provided where steps are added, one or more steps are removed, or one or more steps are provided in a different sequence without departing from the scope of the claims herein.

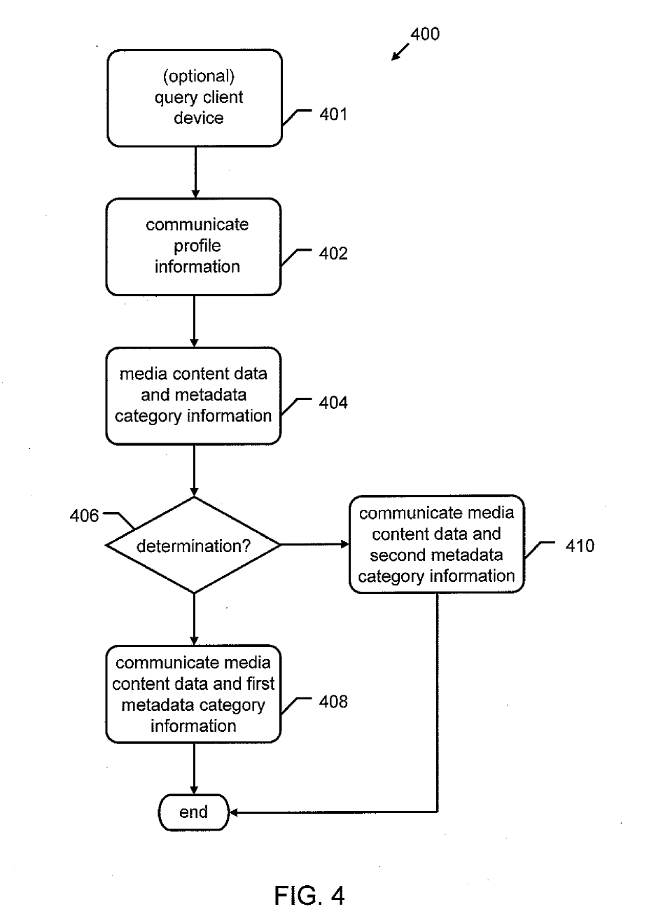

FIG. 4 illustrates a simplified flow diagram 400 according to another embodiment of the present invention. In step 401, a client device can be first queried for profile information. In response to the query or upon a predefined event, the client device communicates profile information to a server in step 402. Next, in step 404, the server accesses media content data and its associated metadata category information. A determination for metadata categories to be communicated, based at least in part upon the profile information, is made in step 406. Finally, during steps 408 or 410, desirable metadata category information is provided to the client device (e.g., a first metadata category information), and undesirable metadata category information (e.g., a second metadata category information) is omitted. In specific embodiments, utility of the desirable metadata category information can preclude expected utility of the undesirable metadata category information. Other alternatives can also be provided where steps are added, one or more steps are removed, or one or more steps are provided in a different sequence without departing from the scope of the claims herein.

While in the above embodiments, the source of media data is upstream and sent from a server (e.g., server 104) to one or more client devices (e.g., client devices 106, 108), in other embodiments of the present invention, the source of media data is in the client device. In such embodiments, the media data with metadata category information is communicated to the server making advantageous use of the present invention. For example, a cellular telephone with integrated camera may capture an A/V scene, and then live stream this content with some generated metadata, but not all metadata, to a remote server. In a specific embodiment, generated metadata can relate to a global positioning system (GPS) or other geographic information for use in geotagging (e.g., adding geographical identification metadata to various media, such as: latitude and longitude coordinates, altitude, bearing, accuracy data, and/or place names) media content.

As another alternative embodiment, media content data can be stored on the client device prior to communication with a server for metadata category information. For example, a library of media (e.g., music, movies, pictures, etc.) can be preexisting on the client device. In this instance, the client device communicates with the server not to obtain media content data, but accumulate desirable or required metadata category information. The metadata category information can be used for improved post-processing.

Implementation Mechanisms—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. The techniques are not limited to any specific combination of hardware circuitry and software, nor to any particular source for the instructions executed by a computing device or data processing system.

The term “storage media” as used herein refers to any media that store data and/or instructions that cause a machine to operation in a specific fashion. It is non-transitory. Such storage media may comprise non-volatile media and/or volatile media. Non-volatile media includes, for example, optical or magnetic disks. Volatile media includes dynamic memory. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics. Transmission media can also take the form of acoustic or light waves, such as those generated during radio-wave and infra-red data communications.

Equivalents, Extensions, Alternatives, and Miscellaneous

In the foregoing specification, possible embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

Additionally, in the foregoing description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention.

What is claimed is:

1. A method for media data communication by a computerized server, the method comprising:
receiving profile information of a client device by the computerized server;
maintaining media content data, first metadata category information and second metadata category information, the first and second metadata category information each associated with the media content data;
determining, based on the profile information, whether the client device is to utilize either the first metadata category information or the second metadata category information;
based upon a determination of utilization of the first metadata category information, transmitting the media content data and the first metadata category information to the client device without transmitting the second metadata category information; and
based upon a determination of utilization of the second metadata category information, transmitting the media content data and the second metadata category information to the client device without transmitting the first metadata category information.

2. The method of claim 1 wherein the first metadata category information includes a parameter for closed caption rendering of the media content data, and the second metadata category information includes a parameter for audio signal processing.

3. The method of claim 1 wherein the first metadata category information includes a parameter for audio speaker virtualization, and the second metadata category information includes a parameter for audio headphone playback.

4. The method of claim 1 wherein the first metadata category information includes a parameter for three dimensional (3D) rendering of the media content data, and the second metadata category information includes a parameter for two dimensional (2D) rendering of the media content data.

5. The method of claim 1 wherein the client device is at least one of a cellular telephone, home network modem, netbook computer, portable computer, electronic book reader, standalone set-top box, digital video recorder (DVR), portable music player, and television set.

6. The method of claim 1 wherein the transmitting is performed at least in part over at least one of a wireless network, cellular network, cable television network, orbiting satellite network, digital subscriber line network, local area network, wide area network, and Internet.

7. A method for media data communication by a computerized server, the method comprising:
receiving profile information of a client device by the computerized server;
maintaining media content data and first metadata category information, the first metadata category information associated with the media content data;
determining, based on the profile information, whether the client device is to utilize the first metadata category information;
based upon a determination of utilization of the first metadata category information, transmitting the media content data and the first metadata category information to the client device; and
based upon a determination of non-utilization of first metadata category information, transmitting the media content data without the first metadata category information to the client device.

8. The method of claim 7 wherein the client device is at least one of a cellular telephone, home network modem, netbook computer, portable computer, electronic book reader, standalone set-top box, digital video recorder (DVR), portable music player, and television set.

9. The method of claim 7 wherein the transmitting is performed at least in part over at least one of a wireless network, cellular network, cable television network, orbiting satellite network, digital subscriber line network, local area network, wide area network, and Internet.

10. The method of claim 7 wherein the first metadata category information includes a parameter for rendering a closed caption for the media content data.

11. The method of claim 7 wherein the first metadata category information includes a parameter for applying Dolby Volume® processing to an audio signal.

12. The method of claim 7 wherein the first metadata category information includes a parameter for audio speaker virtualization.

13. The method of claim 7 wherein the first metadata category information includes a parameter for audio headphone utilization.

14. The method of claim 7 wherein the first metadata category information includes a parameter for three dimensional (3D) rendering of video.

15. The method of claim 7 wherein the first metadata category information includes a parameter for a global positioning system (GPS).

16. The method of claim 7 wherein the profile information uniquely identifies the client device.

17. The method of claim 7 wherein the profile information identifies authorized services available to the client device from the server.

18. The method of claim 7 wherein the profile information identifies an available function on the client device.

19. The method of claim 7 wherein the profile information is received indirectly by the computerized server from the client device.

20. A method for media data communication by a client device, the method comprising:
transmitting profile information of the client device to a computerized server, the profile information indicating an accessible function of the client device; and
receiving media content data and first metadata category information associated with the media content data from the computerized server, the first metadata category information including a parameter used by the accessible function;
wherein the client device does not receive second metadata category information associated with the media content data from the computerized server, the second metadata category information including a parameter unused by the accessible function.

21. A non-transitory computer readable storage medium, comprising software instructions, which when executed by one or more processors cause performance of the method recited in claims 20.

22. An apparatus for media data communication, the apparatus comprising:
a receiver for receiving profile information of a client device by the computerized server;
a database for maintaining media content data and first metadata category information, the first metadata category information associated with the media content data;
a processor for determining, based on the profile information, whether the client device is to utilize the first metadata category information;
based upon a determination of utilization of the first metadata category information, a transmitter for transmitting the media content data and the first metadata category information to the client device; and
based upon a determination of non-utilization of first metadata category information, the transmitter for transmitting the media content data without the first metadata category information to the client device.

23. An apparatus for media data communication, the apparatus comprising:
a means for receiving profile information of a client device by the computerized server;
a means for maintaining media content data and first metadata category information, the first metadata category information associated with the media content data;
a means for determining, based on the profile information, whether the client device is to utilize the first metadata category information;
based upon a determination of utilization of the first metadata category information, a means for transmitting the media content data and the first metadata category information to the client device; and
based upon a determination of non-utilization of first metadata category information, the means for transmitting the media content data without the first metadata category information to the client device.

24. A method for media data communication by a client device, the method comprising:
transmitting profile information of the client device to a computerized server, the profile information indicating that audio playback is muted for the client device; and
receiving media content data and first metadata category information associated with the media content data from the computerized server, the first metadata category information including a parameter for closed captioning;
wherein the client device does not receive second metadata category information associated with the media content data from the computerized server, the second metadata category information including a parameter for audio playback.
